(19) United States
(12) Patent Application Publication
(10) Pub. No.: US 2004/0239831 A1
(43) Pub. Date: Dec. 2, 2004

(54) Display backlight device

(76) Inventors: Perry A. Palumbo, Ft. Collins, CO (US); James P. Goodman, Ft. Collins, CO (US)

Correspondence Address: Dean P. Edmundson, P.O. Box 179, Burton, TX, 77835, US

(21) Appl. No.: 10/859,610

(22) Filed: May 29, 2004

Related U.S. Application Data
(60) Provisional application No. 60/474,967, filed on Jun. 2, 2003.

(51) Int. Cl. G02F 1/1335

(52) U.S. Cl. 349/64

(57) ABSTRACT

A simple monolithic display backlight device is described that is efficient, small in size, and reduces the complexity of display illumination by utilizing a series of planar internal reflecting surfaces and integral cylindrical lens. Also integral to the device is a way to pass electrical connections and signals through the display backlight device to an electrically active display while providing alignment means to the light source, display and display drive circuitry used to actively control the display matrix. The disclosed device provides an area of uniform illumination behind the display at a right angle to the source of light and is well suited for confined space display illumination as in portable and hand-held applications as a result of a minimum number of required components and low height profile.

### CROSS-REFERENCE TO RELATED APPLICATION

This application is based upon, and claims the benefit of, our Provisional Application No. 60/474,967, filed Jun. 2, 2003.

### FIELD OF THE INVENTION

This invention relates to the luminaire and backlight devices used to make a display device or display media visually acute under poor ambient light conditions or under lighting conditions that yield poor contrast between information contained on the display and the background of the display.

### BACKGROUND OF THE INVENTION

An information display that does not onto itself emit light, such as a LCD (liquid crystal display), relies on the transmission or reflection of ambient light in order to make information contained on the display visually perceptible and readable. Under poor ambient light conditions, or lighting conditions below which the visual information represented on the display becomes indistinguishable from the background, means for illuminating the display must be employed to provide enough light to make the display readable. A backlight device provides a convenient means to illuminate the liquid crystal display from behind, transmitting light through, to make the display readable under poor ambient light conditions.

Typically a light guide is incorporated into the backlight, and is employed to transmit light from a light source such as an LED (light emitting diode), bulb, or lamp, located along the edge(s) of the light guide, to an area directly behind the display. Backlight devices rely on the scatter of light along the length and width of one or more of the surfaces of the light guide to provide the apparent source of transmittal illumination. A problem exists with backlight devices where space is limited and the power available to uniformly illuminate the display is limited, such as in the case of portable or hand-held devices. A single light source at close distance to the light guide is incapable of uniformly illuminating the edge of the light guide due to a limited extent of the radiation field or source size. To overcome this problem existing backlights utilize a plurality of light sources spatially distributed along the edge of the light guide upon which individual fields of radiation are combined to form a uniform illuminate condition at the edge and along the extent of the light guide. If the spacing of the sources is too far apart the light emitted from each source is distinctly recognizable, yielding an area of illumination visually inconsistent with the average illumination behind the display. If the spacing between multiple sources is too close then additional costs are incurred in illumination components, cost of assembly, and the cost to power the display to the desired intensity.

Another problem exists with conventional backlight assemblies in which said assemblies require numerous parts to align and retain the display, light guide and light source. Typically a frame is mounted on the PCB (printed circuit board) which contains the light sources, to which the other components are attached and secured by means of screws, snaps, solder or adhesives, prior to incorporation of the display assembly into the final device. Numerous examples of complex illumination assemblies may be cited as follows: U.S. Pat. No. 5,943,801 (Wilkinson), U.S. Pat. No. 5,594,830 (Winston), U.S. Pat. No. 5,313,318 (Gruenberg), U.S. Pat. No. 6,347,882 (Vrudny), U.S. Pat. No. 4,915,478 (Lenko), U.S. Pat. No. 5,134,548 (Turner), U.S. Pat. No. 5,390,276 (Tai), U.S. Pat. No. 5,046,829 (Worp), U.S. Pat. No. 6,039,451 (Grave), U.S. Pat. No. 5,986,728 (Bernard), and U.S. Pat. No. 6,014,192 (Lehureau). A simpler approach is demonstrated with the present invention that significantly reduces assembly complexity, assembly time, and reliability by reducing the number of parts and eliminating the need for additional fasteners, adhesives, or soldering operations.

### SUMMARY OF THE INVENTION

The present invention overcomes the limitations of confined space display illumination while significantly reducing the number of component parts required to assemble, align, and retain a display within an assemblage. As a result, an illuminated display for viewing in poor lighting conditions can be realized with significant reductions to cost, operating power and assembly difficulty.

In accordance with the present invention, light is emitted from a source and radiates away from or through the mounting surface of the light source at a right angle to the surface of which the source is mounted. The mounting surface of the light source is a surface such as that of a PCB. As the emitted light enters the display backlight device the light is refracted in one direction by a cylindrical optical surface. The cylindrical surface assures the light emitted from the source will propagate within the confines of a light guide by means of TIR (total internal reflection) while permitting the light rays to expand along the edge of the light guide. No optical or reflective coatings are required so long as the critical angle of refraction is exceeded. The critical angle of refraction is equal to: sinOc=n/n′. Oc is the critical angle; n is the refractive index of the media in which the display backlight device resides (n=1.000 for air), and n′ is the refractive index of the display backlight device (n′=1.49 for acrylic given at 589 nm). For acrylic, the critical angle for TIR are incident angles of light less than 42 degrees to the surface normal. A plurality of planar TIR surfaces are placed along the path of propagating light so as to increase the effective distance from the light source to the light guide, permitting the radiation to expand and fill the edge of the light guide prior to the light entering the display area. In this manner, fewer light sources are required to obtain the same effective uniform illumination of the light guide. Light propagating within the light guide area, located behind the display, is confined to the light guide by means of TIR along the sides and faces of the light guide. One of the faces of the light guide is selectively textured permitting the propagating light to scatter beyond the confines of the light guide and thus illuminating the display from beneath. An optional reflector may be placed on or behind the textured surface to further enhance the uniformity and brightness of the display backlight device by reflecting light that may otherwise scatter in a direction that would not pass through the display.

In one embodiment, electrical signals pass from the PCB to the display by means of elastomeric conduits inserted into openings or slots in the perimeter of the display backlight device.

### BRIEF DESCRIPTION OF THE DRAWINGS

The invention is described in more detail hereafter with reference to the accompanying drawings.

FIG. 1 is a top view of the preferred embodiment shown from the display side;

FIG. 2 is a cross-sectional view of the preferred embodiment of the invention;

FIG. 3 is a cross-sectional view of the preferred embodiment shown in an assemblage, including case bottom, case top, PCB, display, surface mounted light source, conductive contact strips, and case fastener;

FIG. 4 is a cross-sectional view of the preferred embodiment shown in an assemblage with ray path illustration;

FIG. 5 is a top view of the preferred embodiment shown with ray path illustration, display and conductive contact strips in situ;

FIG. 6 is a cross-sectional view of an alternate embodiment of the invention with light sources on two edges of a non-planar light guide portion of the display backlight device;

FIG. 7 is a cross-sectional view of an alternate embodiment of the invention shown with a light source mounted to the PCB surface opposite to that of which is in contact with the display backlight device; and

FIG. 8 is a cross-sectional view of an alternate embodiment of the invention shown with fewer TIR planar surfaces prior to light entering the light guide area of the display backlight device.

### DETAILED DESCRIPTION OF THE PREFERRED EMBODIMENT

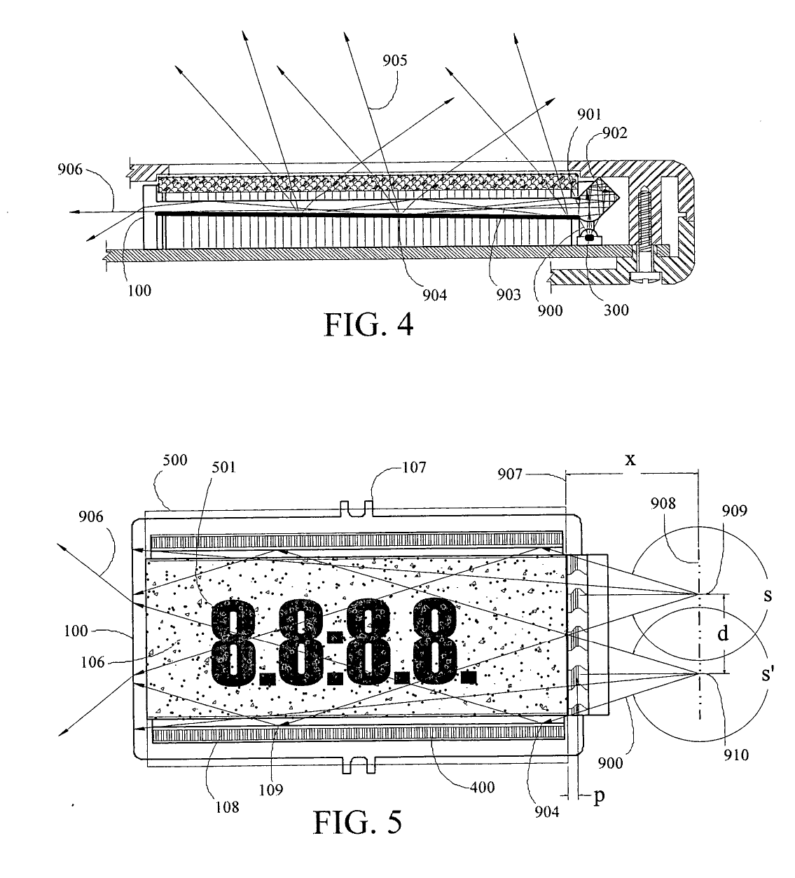

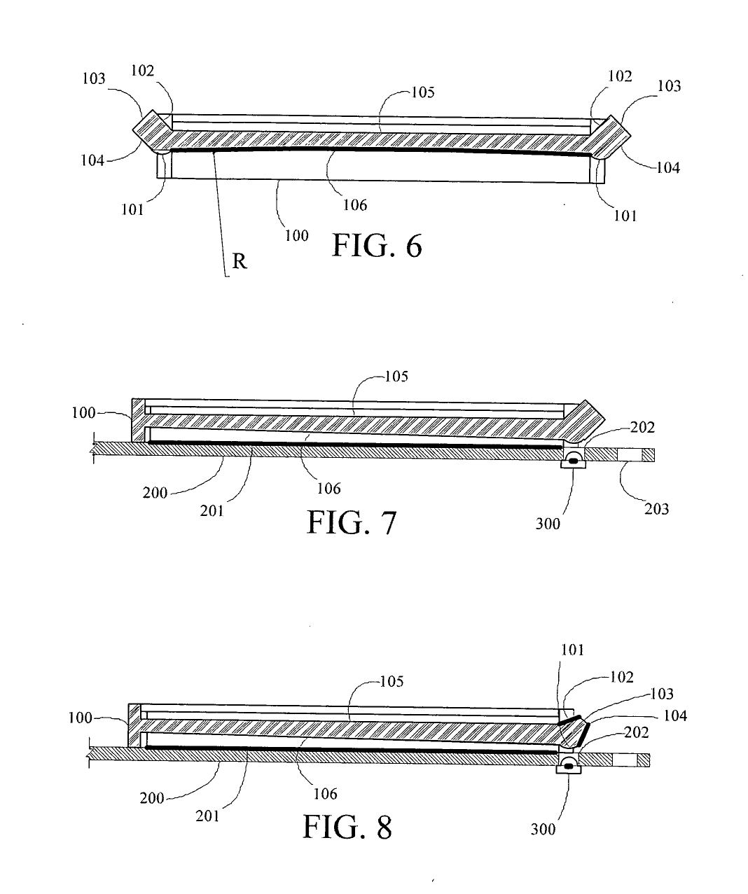

Referring to FIGS. 1-5, there is shown the preferred embodiment of the display backlight device of the present invention. In FIGS. 6-8 are shown alternate embodiment design details that can be incorporated within the scope of the invention, in whole or in part, as desired.

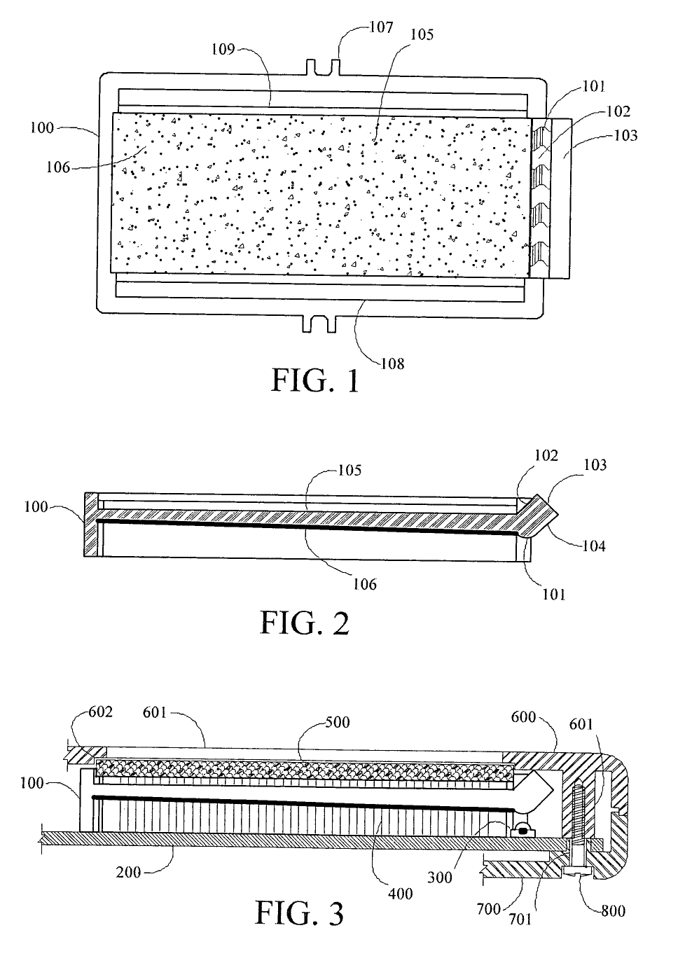

The display backlight device 100, of the preferred embodiment of FIGS. 1 and 2, is a monolithic component made of a transparent material, as examples: optically clear, methyl methacrylate (acrylic) or polycarbonate. Incorporated in the device is a cylindrical lens 101, a series of internally reflecting planar surfaces 102, 103 and 104, a light guide area 105, and a scattering surface 106. In addition, the display backlight device incorporates an alignment feature(s) 107, slotted area(s) 108, and reflective surface(s) 109.

The display backlight device 100 is put into practice in an assemblage typical to that of the example shown in FIG. 3. The display backlight device 100 is located and constrained between a top enclosure half 600 and bottom enclosure half 700 along with the LCD 500, PCB 200, and elastomeric conductors 400. The enclosure halves are held together for example by means of fastener 800 passing through bottom enclosure 700 through boss 701 and into threaded boss 603 of top enclosure 600. Other means may also be employed for attaching the two enclosure halves such as snaps, clips, or adhesives to cite a few. The LCD 500 is loaded into the top enclosure half 600 such that the display is registered to the top enclosure opening 601 by means of counter bore 602. The display backlight device 100 is then placed on top of the LCD 500 and is registered to the top enclosure half by registration feature 107 of display backlight device 100. Elastomeric conductors 400 are inserted into slots 108 on either side of the light guide area 105 of the display backlight device 100. PCB 200 containing light source 300 registers to the top enclosure half 600 and subsequently to display backlight device 100 by through-hole boss 701 and threaded boss 603 of the enclosure halves. When fully assembled, electrical signals are passed through slots 108 of the display backlight device 100 from PCB 200 to LCD 500 by means of elastomeric conductors 400. Elastomeric conductors 400 comprised of threads of conductive material such as carbon, silver, or gold, in strata of insulating material such as silicone rubber (as example, ZEBRA elastomeric connector, type FL-LS by Fujipoly America Corporation). Elastomeric conductors 400 serve also to provide compliance to compensate for variation in the thickness of LCD 500 and PCB 200 by compression of the elastomeric conductors 400.

Referring to FIGS. 1-5, light propagates from emitting light source 300 through LCD 500 by intervention of the display backlight device 100. Emitted light 900 from light source 300 enters the display backlight device 100 through cylindrical surface 101 and is sufficiently collimated 901 promoting TIR in the axis of refraction within the confines of the display backlight device 100. Propagation of light 902 continues towards the light guide area 105 by reflections off planar surfaces 102, 103 and 104. The planar surfaces need not be coated as long as the incident light on said surfaces exceeds the critical angle for the material of which the display backlight device 100 is constructed for operation in the design media, i.e. air. The effective distance x, in FIG. 5, between light source 300 and light guide area 105 is increased from distance p by the internal reflections of planar surfaces 102, 103 and 104. By increasing the effective distance from p to x, the edge 907 of the light guide area 105 can be fully illuminated with fewer light sources. Two light sources 909 and 910 separated by distance d emit light within solid angles s and s′ respectively and satisfies the illumination criteria of “fully illuminated” while maintaining real distance p from the light guide area 105. Thus, the backlight task is accomplished while significantly reducing the required space and number of light sources to perform the backlight task. Light 903, upon entering the light guide area 105, can internally reflect as 904 or propagate outside the confines of the light guide area 105 as ray 905 by encounter with scattering surface 106. Light propagating across the width of light guide area 105 is internally reflected by surfaces 109 formed by slots 108. Scattering surface 106 is sufficiently opaque and diffusely reflective to cause a portion of the light scattered from the encounter to impinge at an angle less than the critical angle of TIR of light guide area 105. This permits the diffusely reflected light to pass from the light guide area 105 through LCD 500 to illuminate the display information 501. As light propagates light guide area 105 a loss occurs due to the escape of light through the LCD 500 decreasing the intensity of the backlight illumination for greater propagation distance. Setting the planar surfaces of light guide area 105 to a non-parallel condition, the distance between the surfaces decreasing along the path of propagation, the impingement angle of light on the surfaces becomes more normal with each reflection. Eventually the incidence angle of the reflected light 903 impinging upon the surfaces of light guide area 105 becomes less than that which is required to achieve TIR. Thus the rate of light loss or transmission through the display is made greater for a greater distance of light propagation within the light guide area 105. This increasing rate of light loss compensates for the diminished intensity along the path propagation within the light guide area 105 resulting in uniform illumination of LCD 500. Light not diffusely reflected by scattering surface 106 exits the light guide area 105 as ray 906 at the end of the light guide area 105 opposite light source 300. By judicious selection of the parallelism of the surfaces of the light guide area 105, the texture and reflectivity of the scattering surface 106, the propagation of light 906 through the light guide area 105 without dispersion can be minimized. Scattering surface 106 can be a coated textured surface, or a textured surface affixed with an opaque reflector such as white or metal adhesive label. The texture can be created by acid etching or scribing the tool from which the surface is formed in the molding process. Alternatively, the surface can be textured directly by means of a secondary process such as abrasive sanding, sandblasting, or other means to render the surface non-smooth or without fine structure.

An alternate embodiment of the present invention is shown in FIG. 6 wherein a second cylindrical surface 101, a second light source 300, and a second set of planar surfaces 102, 103 and 104 are included on light guide 105 at an end opposite that of the first arrangement of components. The alternate embodiment of FIG. 6 is useful when the length of the light guide 105 is excessive, causing the intensity and uniformity of the backlight illumination to diminish as light propagates the length of the backlight, or the desired brightness of the backlight illumination is high. Scattering surface 106 is curved along the length of light guide area 105 with the center of said curve to be substantially centered between the two emitting edges of light guide area 105. The curvature of scattering surface 106 promotes light propagating the light guide area 105 to impinge at angles more normal to the surface of the light guide area 105 for increased distance traveled by the light within the light guide area 105. The variable impingement angle permits light to escape through the display at a higher rate for greater propagation distances. Since less light is available due to the transmission of light through the display as the light propagates the light guide area 105 the increased loss rate results in a more uniformly illuminated display than that which could be achieved with parallel surfaces of light guide 105. The curved surface of 106 behaves in a manner nearly identical to that of making the surfaces of the light guide area 105 non-parallel as in the preferred embodiment without an obvious line of intersection formed by the intersection of two non-parallel planes.

Another alternative embodiment of the present invention is shown in FIG. 7 in which the thickness of the display backlight device 100 can be further reduced by mounting the light source 300 on PCB 200 opposite that to which the display backlight device 100 is in contact. Light from light source 300 emits through hole 202 in PCB 200 towards cylindrical surface 101 of display backlight device 100. Further benefit to this arrangement permits the scattering surface 106 of the light guide area 105 to be diffuse without possessing reflectance characteristics. Light scattered from diffuse surface 106 is reflected back through light guide area 105 and subsequently through LCD 500 by reflectance coating 201 of PCB 200. The reflectance coating 201 can be that of any reflectance material such as a label, paint or silkscreen placed on PCB 200 during the normal manufacturing process occupying an area substantially the same as the light guide area 105, thus further reducing the assembly cost and time.

Still another embodiment of the current invention is shown in FIG. 8 in which the number of planar surfaces 102, 103 and 104 and the distance between the planar surfaces is modified. This embodiment is useful for selection of the effective distance between the light source 300 and the edge of the light guide area 105 without increasing the size of the planar surfaces. When the incident angle to said planar surfaces is less than that to achieve TIR, a reflective coating must be applied to planar surfaces 102 and 104 as shown in FIG. 8. Planar surface 103 need not be coated as this surface serves only to maintain separation of optical surfaces 102 and 104. An additional benefit of this embodiment is realized to contain fewer optical surfaces to achieve the effective increase in distance from light source 300 to light guide 105 of the present invention. Still another benefit of this arrangement is a reduction in the volume encompassed by the cylindrical surface 101 and the planar surfaces 102, 103 and 104. The decrease in volume permits injection molding of the surfaces with greater surface accuracy by virtue of less deformed shrinkage of optical surfaces 102 and 104 for a given injection molding processing of the display backlight device 100.

What is claimed is:

1. A display backlight device comprising a light guide comprising a substantially monolithic light transparent material which includes at least one planar internal surface for reflecting light from a light source through said transparent material by means of internal reflection; wherein said light guide further comprises a light scattering surface.

2. A display backlight device in accordance with claim 1, further comprising a cylindrical lens positioned so as to transmit light from a light source to said planar internal surfaces.

3. A display backlight device in accordance with claim 2, wherein said cylindrical lens is integral with said light guide.

4. A display backlight device in accordance with claim 3, wherein said cylindrical lens is capable of collimating light from a light source in one axis.

5. A display backlight device in accordance with claim 1, wherein said light guide comprises at least two planar internal surfaces.

6. A display backlight device in accordance with claim 1, wherein said light scattering surface is sufficiently opaque and diffusely reflective to scatter light away from said light tube.

7. A display backlight device in accordance with claim 1, further comprising at least one opening therethrough, and further comprising an electrical conductor extending through said opening.

8. A display backlight device in accordance with claim 7, wherein said opening includes at least one reflecting surface.

9. A display backlight device in accordance with claim 1, wherein said light guide comprises two planar external surfaces, wherein one of said external surfaces is coated with a light-reflecting coating.

10. A display backlight device in accordance with claim 9, wherein said planar external surfaces are non-parallel to each other.

11. A display backlight device in accordance with claim 1, wherein said light scattering surface is curved.

12. A display backlight device in accordance with claim 1, wherein said light scattering surface comprises a textured surface and a separate opaque reflecting surface.

13. A display backlight device in accordance with claim 1, wherein said light guide comprises first and second ends, and wherein each said end includes at least one planar internal surface for reflecting light from a separate light source.

14. A display backlight device in accordance with claim 1, wherein said light scattering surface is substantially perpendicular to light entering said light guide from a light source.

15. A liquid crystal display comprising:
a display panel having a top view surface and a bottom surface;
a light guide positioned below said bottom surface of said panel; said light guide comprising a substantially monolithic light transparent material which includes at least one planar internal surface for reflecting light from a light source through said transparent material by means of internal reflection; wherein said light tube further comprises a light-scattering surface.
